(19) United States
(12) Patent Application Publication
(10) Pub. No.: US 2014/0360465 A1
(43) Pub. Date: Dec. 11, 2014

(54) COLD STARTING DEVICE AND COLD STARTING METHOD FOR VEHICLE

(71) Applicant: Hyundai Motor Company, Seoul (KR)

(72) Inventors: Chang Jun PARK, Changwon-Si (KR); Myeong Hwan KIM, Hwaseong-si (KR); Chang Han KIM, Gwangju-si (KR)

(73) Assignee: Hyundai Motor Company, Seoul (KR)

(21) Appl. No.: 14/139,268

(22) Filed: Dec. 23, 2013

(30) Foreign Application Priority Data
Jun. 7, 2013 (KR) 10-2013-0065500

(51) Int. Cl. F02N 19/04

(52) U.S. Cl. CPC F02N 19/04
USPC 123/403

(57) ABSTRACT

A cold starting apparatus and a cold starting method for a vehicle may include: a throttle body configured to make air flow in an engine; a heater device installed at the throttle body, and configured to preheat the air passing through the throttle body; and a cold starting injector installed at the throttle body in front of the heater device so that the fuel is preheated while passing through the heater device, and configured to spray the fuel into the throttle body, thereby improving cold starting performance of the vehicle.

### CROSS-REFERENCE TO RELATED APPLICATION

The present application claims priority of Korean Patent Application Number 10-2013-0065500 filed Jun. 7, 2013, the entire contents of which application is incorporated herein for all purposes by this reference.

### BACKGROUND OF INVENTION

1. Field of Invention

The present invention relates to a cold starting apparatus and a cold starting method for a vehicle, which cold starts a vehicle by preheating fuel and air by using a positive temperature coefficient (PTC) element and supplying the preheated fuel and air to an engine when cold starting the vehicle in a state where an outside air temperature is low.

2. Description of Related Art

In general, bioethanol refers to ethanol for fuel produced by injecting water, enzyme, sugar, yeast, and the like to sugar cane or corn powder, distilling the mixture, and then separating alcohol from the mixture.

The bioethanol has a high octane number and is closely completely combusted to serve as environmentally-friendly fuel, and is advantageous in improving output, so that the bioethanol is used as fuel for a vehicle, but the bioethanol has a low heating value, and thus is disadvantageous in view of fuel efficiency for a vehicle.

Further, in a flex fuel vehicle (FFV) using the bioethanol as fuel, a temperature of an ignition point of the bioethanol is 12° C., which is relatively high, so that a problem of starting the flex fuel vehicle occurs.

That is, when an outside air temperature is a temperature slightly higher than the temperature of the ignition point, for example, 15° C. or lower, there occurs a case in which the flex fuel vehicle does not start well, and various methods have been developed and applied in order to improve cold starting performance of the flex fuel vehicle.

As one method for improving cold starting performance of the flex fuel vehicle, there is a method of using gasoline fuel as a starting fuel for the flex fuel vehicle.

That is, a fuel supplying system for cold starting, which supplies gasoline as fuel for cold starting to a bioethanol fuel supplying system of the flex fuel vehicle that supplies bioethanol as fuel of the engine, is additionally installed.

The fuel supplying system for cold starting includes an auxiliary fuel tank for storing gasoline fuel, an auxiliary fuel pump for pumping and supplying the gasoline fuel, and a solenoid valve as a control valve for controlling the supply and block of the gasoline fuel.

When an outside air temperature is, for example, 15° C. or lower, the flex fuel vehicle including the aforementioned fuel supplying system for cold starting is started by spraying the gasoline fuel to a rear side of a throttle body as fuel for starting by using the fuel supplying system for cold starting.

However, since the aforementioned gasoline fuel supplying system for cold starting is additionally installed in order to improve cold starting performance, there is a drawback in that a weight of the flex fuel vehicle is increased and a cost is increased.

Further, in a case where a crash accident occurs while the flex fuel vehicle travels, the auxiliary fuel tank and relevant components thereto are broken, such that a risk of fire occurrence is high due to a leakage of the gasoline fuel, and marketability of the vehicle is decreased due to an operational noise of the auxiliary fuel pump.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a cold starting apparatus and a cold starting method for vehicle, which is capable of improving cold starting performance of the vehicle by preheating fuel and air and supplying the preheated fuel and air to an engine when cold starting the vehicle in a state where an outside air temperature is low

Various aspects of the present invention provide for a cold starting apparatus for a vehicle, including: a throttle body configured to make air flow in an engine; a heater device installed at the throttle body, and configured to preheat the air passing through the throttle body; and a cold starting injector installed at the throttle body in front of the heater device so that the fuel is preheated while passing through the heater device, and configured to spray the fuel into the throttle body.

The throttle body may be formed in a cylindrical shape including an air inlet through which air flows in, an air passage through which the air flowing in through the air inlet flows, and an air outlet through which the air passing through the air passage is discharged to the outside of the throttle body, a fuel spraying hole, through which the fuel is sprayed into the air passage through the cold starting injector, may be formed at a portion close to the air outlet side of the throttle body, and the heater device may be installed at the air passage between the fuel spraying hole and the air outlet.

The heater device may include: a terminal configured to supply a power source from the outside; a case shaped like a quadrangular box; and a heater unit accommodated inside the case, and configured to emit heat by receiving an external power source through the terminal.

The heater unit may include: one or more heating rods shaped like a rectangular bar; and one or more radiation pins integrally attached to both side surfaces of the heating rod.

The radiation pin may have a shape in which a thin plate is bent in a zigzag shape so that the air and the fuel receive heat while passing through the radiation pin.

The radiation pin may be attached to both side surfaces of the heating rod by thermal conductive bonding.

An insulating layer, a plus terminal, and one or more positive temperature coefficient (PTC) elements may be sequentially stacked and accommodated inside the heating rod.

Each of the insulating layer and the plus terminal may be shaped like a thin, narrow, and relatively long rectangular plate.

The PTC element may be shaped like a rectangular bar, and may be fitted and coupled to a PTC frame formed of a plastic material.

The cold starting apparatus may further include: a fuel pump configured to supply the fuel to the cold starting injector; an auxiliary fuel supply line configured to connect the fuel pump and the cold starting injector; a cold starting opening/closing valve configured to open/close the auxiliary fuel supply line; and an engine control unit configured to detect an outside air temperature, and control the cold starting injector and the cold starting opening/closing valve according to the outside air temperature.

The fuel may be a bioethanol fuel.

Various aspects of the present invention provide for a cold starting method for a vehicle, including: detecting an outside air temperature; when the outside air temperature is equal to or lower than a predetermined temperature, spraying a fuel to a throttle body; and preheating the fuel sprayed to the throttle body and air passing through the throttle body.

The cold starting method may further include, when a door of the vehicle is opened or ignition is on before the detecting of the outside air temperature, operating a fuel pump of the vehicle.

The preheating of the fuel and the air may be performed by a heater device installed at the throttle body.

The preheating may include displaying a state in which the fuel and the air is currently preheated on a cluster.

The cold starting method may further include determining whether a starting attempt is made before the spraying and the preheating, and when it is determined that the starting attempt is not made for a predetermined time, not executing the spraying and the preheating.

The cold starting method may further include, when it is determined that the starting attempt is made, detecting revolutions per minute of the engine after executing the spraying and the preheating, and when the revolutions per minute of the engine is equal to or larger than predetermined revolutions per minute, stopping the spraying and the preheating.

The cold starting method may further include, when the revolutions per minute of the engine is smaller than the predetermined revolutions per minute, counting the number of starting attempts, and when the number of starting attempts is equal to or larger than the predetermined number of times, stopping the spraying and the preheating, but when the number of starting attempts is smaller than the predetermined number of times, continuously executing the spraying and the preheating.

The fuel may be the bioethanol fuel.

According to the cold starting apparatus and the cold starting method for the vehicle according to various aspects of the present invention, air and fuel in a state of being heated to a predetermined temperature or higher by the heater device installed at the throttle body may flow in the engine, thereby improving cold starting performance of the vehicle.

When the cold starting apparatus and the cold starting method for the vehicle according to various aspects of the present invention are applied to a flex fuel vehicle using bioethanol as fuel, in a case where an outside air temperature is, for example, 18° C. or lower, the fuel may flow in the engine by heating the fuel of bioethanol at an appropriate temperature, thereby improving cold starting performance of the flex fuel vehicle.

Further, in order to improve the cold starting performance of the flex fuel vehicle, it is not necessary to use a separate auxiliary fuel for starting, such as gasoline, and the relevant devices thereto, thereby promoting a decrease in weight and cost of the vehicle.

Further, when the heater device is operated for a predetermined time even after cold starting the vehicle, it is possible to improve initial fuel efficiency of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view illustrating an exemplary heater device of a cold starting apparatus for a vehicle according to the present invention applied to a throttle body.

FIG. 2 is a perspective view of the heater device of FIG. 1.

FIG. 3 is an exploded perspective view illustrating an exemplary heater unit according to the present invention.

FIG. 4 is a cross-sectional view in an exemplary state where a radiation pin is attached to a heating rod according to the present invention by thermal conductive bonding.

FIG. 5 is a cross-sectional view taken along line A-A of FIG. 3.

FIG. 6 is an exploded perspective view illustrating an exemplary heating rod according to the present invention.

FIG. 7 is an exemplary configuration diagram illustrating the cold starting apparatus for the vehicle according to the present invention.

FIG. 8 is a flowchart illustrating an exemplary cold starting method for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

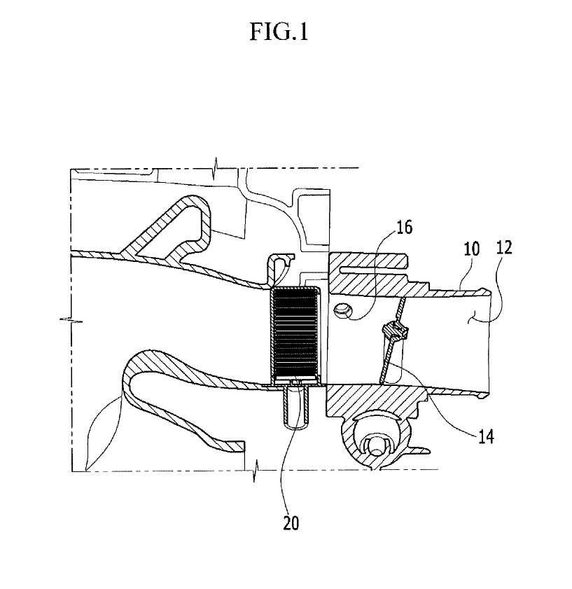

Referring to FIG. 1, a cold starting apparatus for a vehicle according to various embodiments of the present invention may be applied to a throttle body 10 by which air flows into an engine.

That is, the cold starting apparatus for the vehicle may include a heater device 20 installed at an outlet side, from which the air is discharged, in the throttle body 10.

The throttle body 10 may be formed in a cylindrical shape including an air inlet through which air flows in, an air passage 12 through which the air flowing in through the air inlet flows, and an air outlet through which the air passing through the air passage is discharged to the outside of the throttle body 10.

A throttle valve 14 for controlling the amount of air flowing in through the air inlet and discharged through the air outlet may be installed at the air passage.

The throttle body 10 may be provided with a fuel spraying hole 16 for spraying fuel into the air passage close to the air outlet side based on the throttle valve 12.

The heater device 20 is installed at the air passage 12 between the fuel spraying hole 16 and the air outlet, such that the air passing through the throttle valve and the fuel sprayed through the fuel spraying hole 16 flow in the engine after passing through the heater device.

Accordingly, the air flowing in the throttle body 10 and the fuel sprayed to the throttle body 10 are appropriately heated by the heater device 20 before flowing in the engine, so that the air flowing in the throttle body 10 and the fuel sprayed to the throttle body 10 may flow in the engine in a preheated state.

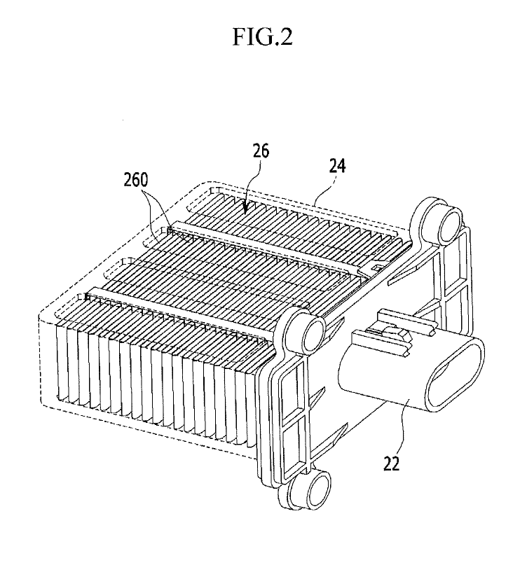

Referring to FIG. 2, the heater device 20 may include a terminal 22 for supplying a power source from the outside, a case 24 approximately shaped like a quadrangular box, and a heater unit 26 accommodated inside the case 24 to emit heat by receiving the external power source through the terminal.

The heater unit 26 may have a structure in which a plurality of radiation pins 260, through which the air and the fuel pass and are heat exchanged, is stacked.

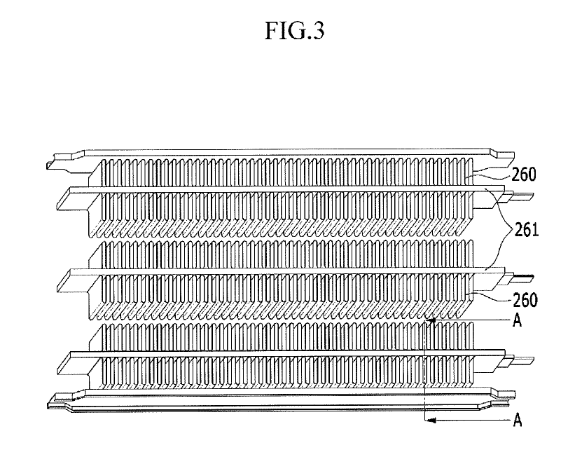

Referring to FIG. 3, the heater unit 26 may have a structure in which the radiation pins 260 are integrally attached to both side surfaces of one or more heating rods 261 approximately shaped like a rectangular bar.

The radiation pin 260 may have a shape in which a thin plate is bent in a zigzag shape.

The air and the fuel receive the heat from the radiation pins 260 while passing through spaces between the radiation pins 260.

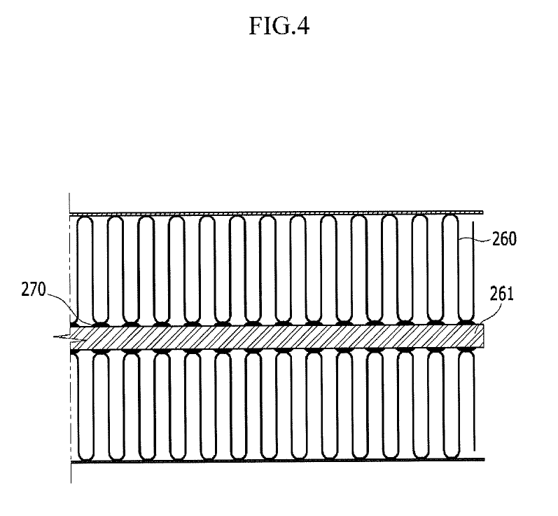

Referring to FIG. 4, the radiation pins 260 may be attached to both side surfaces of the heating rod 261 by thermal conductive boding 270.

Accordingly, a contact area between the radiation pin 260 and the heating rod 261 is increased by the thermal conductive bonding 270, so that efficiency of heat transference between the radiation pin 260 and the heating rod 261 is improved.

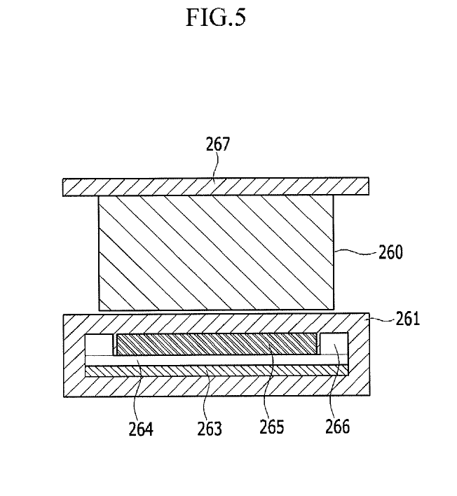

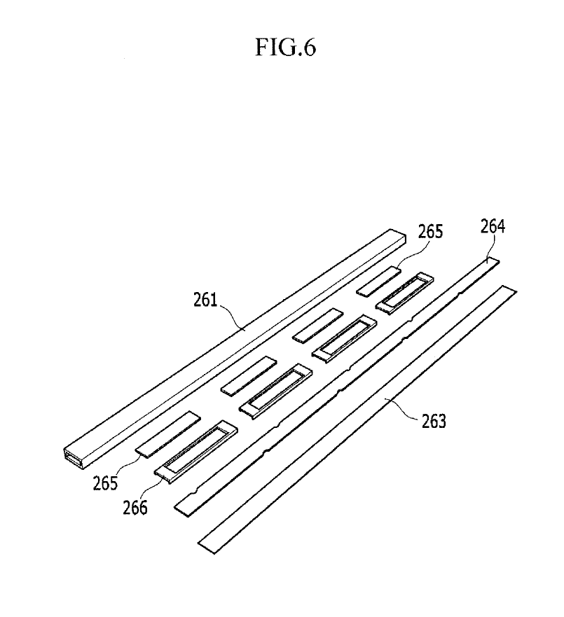

Referring to each of FIG. 5 and FIG. 6, an insulating layer 263, a plus terminal 264, and one or more positive temperature coefficient (PTC) elements 265 may be sequentially stacked and accommodated inside the heating rod 261.

Each of the insulating layer 263 and the plus terminal 264 may be formed in a shape of a thin, narrow, and relatively long rectangular plate.

The PTC element 265 may be formed in an approximately rectangular bar shape, and may be fitted and coupled to a PTC frame 266 formed of a plastic material.

The PTC frame 266 allows the PTC element 265 to be fitted thereto to serve to support the PTC element 265

The PTC element 265 is stacked on the plus terminal 264, so that the PTC element 265 generates heat by receiving external power source through the plus terminal 264, and the generated heat is thermally conducted to the heating rod 261.

The insulating layer 263 serves to insulate the plus terminal 264 from the heating rod 261.

A minus terminal 267 may be connected to one side portion of the radiation pin 260.

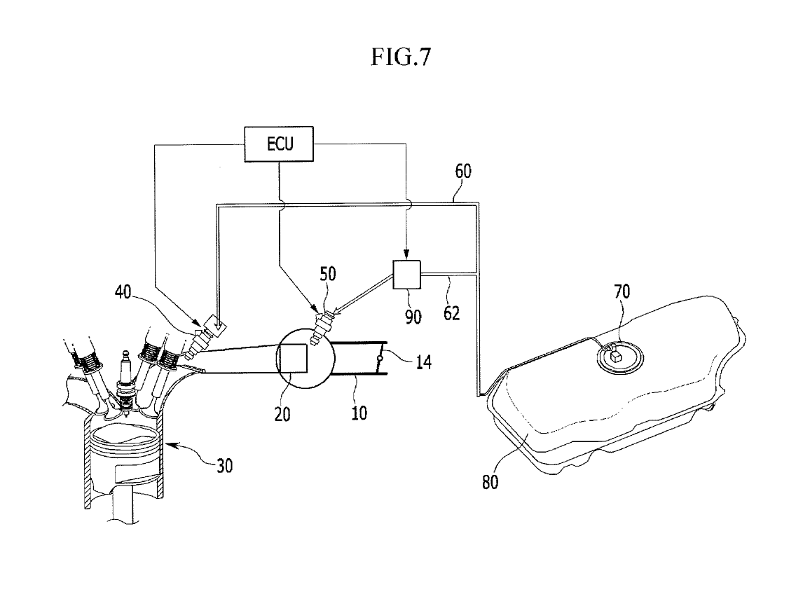

Referring to a configuration of the cold starting apparatus for the vehicle according to various embodiments of the present invention illustrated in FIG. 7, a main injector 40 for spraying fuel necessary for driving the vehicle is installed at a cylinder head of the engine 30.

In order to make the air flow in the engine 30, the throttle body 10 is connected to the engine 30.

The heater device 20 is installed at the throttle body 10, to preheat the air flowing in the engine 30 through the throttle body 10 at an appropriate temperature.

A cold starting injector 50 is installed at the throttle body 10 at an upstream side of the heater device 20 in an air flow course.

The cold starting injector 50 serves to spray cold starting fuel when cold starting the vehicle in a state where an outside air temperature is equal to or lower than a predetermined temperature, for example, 18° C.

The main injector 40 and the cold starting injector 50 are connected with a fuel pump 70 through a fuel supply line 60, and the fuel pump 70 is installed at the fuel tank 80 capable of storing the predetermined amount of fuel, so that a fuel pump 70 pumps the fuel of the fuel tank 80 and supplies the fuel to each of the main injector 40 and the cold starting injector 50.

A cold starting opening/closing valve 90 may be installed at an auxiliary fuel supply line 62 branched from the fuel supply line 60 to be connected with the cold starting injector 50.

The cold starting opening/closing valve 90 serves to open or close the auxiliary fuel supply line 62 as necessary.

The cold starting opening/closing valve 90 may be formed of, for example, a solenoid valve, and be operated by receiving a control signal from an electronic control unit or an engine control unit (ECU).

The air flowing in through the air inlet of the throttle body 10 and the cold starting fuel sprayed from the cold starting injector 50 are supplied to the engine 30 in a state where the air flowing in through the air inlet of the throttle body 10 and the cold starting fuel sprayed from the cold starting injector 50 are preheated by appropriate heat exchange with the heater device 20 while passing through the heater device 20 installed at the throttle body 10, thereby improving cold starting performance of the vehicle.

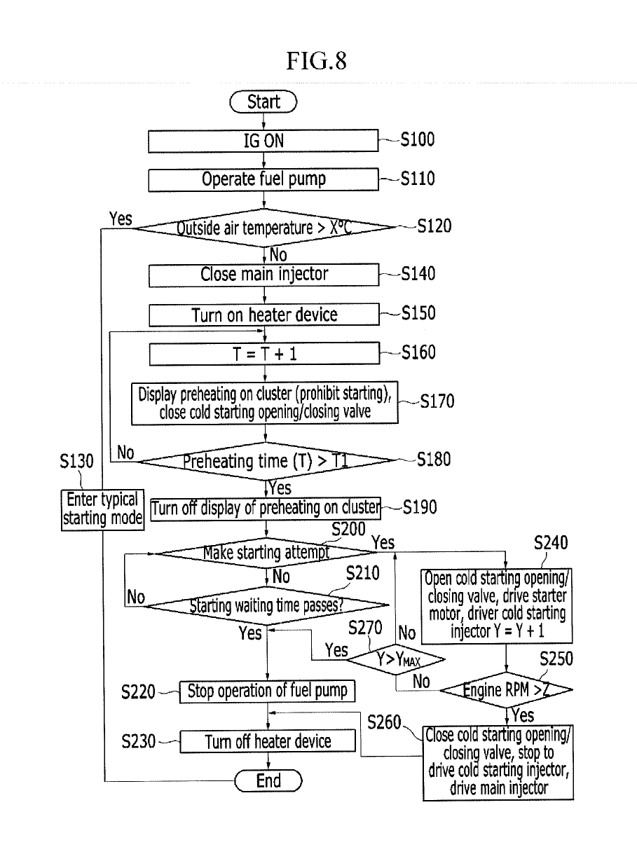

More particularly, the electronic control unit or the engine control unit (ECU) performs the control according to a control flowchart illustrated in FIG. 8.

First, when a starting attempt for a vehicle, such as ignition-on IG-ON of the vehicle or opening a door of the vehicle by a smart key, is made (S100), the engine control unit controls the fuel pump 70 to be operated (S110).

Next, the engine control unit detects an outside air temperature through a temperature sensor and the like, and determines whether the detected outside air temperature is higher than a predetermined reference temperature X° C. (S120).

In a case of a flex fuel vehicle using bioethanol as fuel, the reference temperature X° C. may be set to, for example, 18° C.

In a case of a vehicle using diesel or gasoline as fuel, the reference temperature X° C. may be set to other temperatures.

When the detected outside air temperature is higher than the predetermined reference temperature X° C., there is no problem in starting performance of the vehicle, so that the engine control unit enters a typical starting mode (S130).

The typical starting mode means to start the vehicle by spraying the fuel to the engine by using the main injector 40.

When the detected outside air temperature is lower than the predetermined reference temperature X° C., there may incur a problem in starting performance in a case of the flex fuel vehicle using bioethanol as fuel, that is, the vehicle may not be started well, so that the engine control unit enters a cold starting mode according to a next step in the control flowchart.

The cold starting mode means to appropriately preheat fuel and air with the heater device 20 and supply the preheated fuel and air to the engine.

When the engine control unit enters the cold starting mode, the fuel is not sprayed to the main injector 40, so that the engine control unit performs a close control on the main injector 40 (S140).

Further, in order to preheat the fuel and the air by heating the fuel and the air, the engine control unit performs an on-operation so as to drive the heater device 20 (S150).

Next, the engine control unit counts a preheating time T in order to preheat the fuel and the air for a predetermined time in the cold starting mode (S160), and notifies a driver of a state that the fuel and the air are currently preheated by displaying the state on a cluster, and controls so that the cold starting opening/closing valve 90 to maintain a closed state (S170).

The preheating time T may be set to an appropriately predetermined time T1.

When the preheating time T passes the predetermined time T1 (S180), the engine control unit turns off a preheating display displayed on the cluster, and notifies the driver of a completion of the preheating (S190).

The engine control unit determines whether the driver has an intention to drive the vehicle after the preheating is completed. That is, the engine control unit determines whether a starting attempt is made (S200).

When no starting attempt is made, the engine control unit continuously determines whether the starting attempt is made for a starting waiting time (S210), and when the starting waiting time elapses (S210), the engine control unit determines that the driver has no intention to drive the vehicle and stops the operation of the fuel pump 70 (S220), and turns off the heater device 20 (S230) to terminate the process.

When it is determined that the starting attempt is made in the starting attempt determination step (S200), the engine control unit considers that the driver has the intention to drive the vehicle, and opens the cold starting opening/closing valve 90 by applying a control signal to the cold starting opening/closing valve 90, also drives a starter motor, drives the cold starting injector 50 by applying the control signal even to the cold starting injector 50, and counts the number Y of times of starting (S240).

When the cold starting fuel is supplied to the cold starting injector 50 by opening the cold starting opening/closing valve 90 as described above, the cold starting injector 50 sprays the cold starting fuel to the throttle body 10, the cold starting fuel sprayed to the throttle body 10 and the air flowing in the throttle body 10 are preheated at an appropriate temperature by receiving heat from the heater device 20 while passing through the heater device 20, and the preheated cold starting fuel and air flow in the engine 30 to start the vehicle, thereby improving cold starting performance of the vehicle.

The engine control unit determines whether revolutions per minute RPM of the engine is equal to or larger than reference revolutions per minute Z in order to determine whether the vehicle is appropriately started (S250), and when the revolutions per minute RPM of the engine is equal to or larger than the reference revolutions per minute Z, the engine control unit determines that the vehicle is appropriately started, and controls the cold starting opening/closing valve 90 to be closed, controls so that the driving of the cold starting injector 50 is stopped, and controls the main injector 40 to be driven (S260).

Then, the engine control unit controls the heater device 20 to be turned off, so that the cold starting mode is terminated.

In the meantime, when the revolutions per minute RPM of the engine is smaller than the reference revolutions per minute Z, the engine control unit determines whether the number Y of starting attempts is equal to or larger than the permitted number Ymax of starting attempts (S270), when the number Y of starting attempts is equal to or larger than the permitted number Ymax of starting attempts, the process proceeds to step S220 so that the cold starting mode is terminated, but when the number Y of starting attempts is smaller than the permitted number Ymax of starting attempts, the process returns to step S240, so that the cold starting attempt is continuously made.

For convenience in explanation and accurate definition in the appended claims, the terms front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cold starting apparatus for a vehicle, comprising:
a throttle body configured to control air flow into an engine;
a heater device installed at the throttle body, and configured to preheat the air passing through the throttle body; and
a cold starting injector installed at the throttle body upstream of the heater device so that fuel sprayed into the throttle body is preheated while passing through the heater device before the fuel enters the throttle body.

2. The cold starting apparatus of claim 1, wherein:
the throttle body has a cylindrical shape including an air inlet through which air flows in, an air passage through which the air flowing in through the air inlet flows, and an air outlet through which the air passing through the air passage is discharged to the outside of the throttle body;
a fuel spraying hole, through which the fuel is sprayed into the air passage through the cold starting injector, is formed at a portion close to the air outlet side of the throttle body; and
the heater device is installed at the air passage between the fuel spraying hole and the air outlet.

3. The cold starting apparatus of claim 1, wherein:
the heater device comprises:
a terminal configured to supply a power source from the outside;
a case shaped like a quadrangular box; and
a heater unit received within the case, and configured to emit heat by receiving an external power source through the terminal.

4. The cold starting apparatus of claim 3, wherein:
the heater unit comprises:
one or more heating rods shaped like a rectangular bar; and
one or more radiation pins integrally attached to both side surfaces of the heating rod.

5. The cold starting apparatus of claim 4, wherein:
the radiation pin has a shape in which a thin plate is bent in a zigzag shape so that the air and the fuel receive heat while passing through the radiation pin.

6. The cold starting apparatus of claim 5, wherein:
the radiation pin is attached to both side surfaces of the heating rod by thermal conductive bonding.

7. The cold starting apparatus of claim 4, wherein:
an insulating layer, a plus terminal, and one or more positive temperature coefficient (PTC) elements are sequentially stacked and accommodated inside the heating rod.

8. The cold starting apparatus of claim 7, wherein:
each of the insulating layer and the plus terminal is shaped like a thin, narrow, and relatively long rectangular plate.

9. The cold starting apparatus of claim 7, wherein:
the PTC element is shaped like a rectangular bar, and is fitted and coupled to a PTC frame formed of a plastic material.

10. The cold starting apparatus of claim 1, further comprising:
a fuel pump configured to supply the fuel to the cold starting injector;
an auxiliary fuel supply line configured to connect the fuel pump and the cold starting injector;
a cold starting opening/closing valve configured to open/close the auxiliary fuel supply line; and
an engine control unit configured to detect an outside air temperature, and control the cold starting injector and the cold starting opening/closing valve according to the outside air temperature.

11. The cold starting apparatus of claim 1, wherein:
the fuel is a bioethanol fuel.

12. A cold starting method for a vehicle, comprising:
detecting an outside air temperature;
when the outside air temperature is equal to or lower than a predetermined temperature, spraying a fuel to a throttle body; and
preheating air passing through the throttle body and the fuel sprayed to the throttle body.

13. The cold starting method of claim 12, further comprising:
when a door of the vehicle is opened or ignition is on before the detecting of the outside air temperature, operating a fuel pump of the vehicle.

14. The cold starting method of claim 12, wherein:
the preheating of the fuel and the air is performed by a heater device installed at the throttle body.

15. The cold starting method of claim 12, wherein:
the preheating includes displaying a state in which the fuel and the air is currently preheated on a cluster.

16. The cold starting method of claim 12, further comprising:
determining whether a starting attempt is made before the spraying and the preheating, and when it is determined that the starting attempt is not made for a predetermined time, not executing the spraying and the preheating.

17. The cold starting method of claim 16, further comprising:
when it is determined that the starting attempt is made, detecting revolutions per minute of the engine after executing the spraying and the preheating, and when the revolutions per minute of the engine is equal to or larger than predetermined revolutions per minute, stopping the spraying and the preheating.

18. The cold starting method of claim 17, further comprising:
when the revolutions per minute of the engine is smaller than the predetermined revolutions per minute, counting the number of starting attempts, and when the number of starting attempts is equal to or larger than the predetermined number of times, stopping the spraying and the preheating, but when the number of starting attempts is smaller than the predetermined number of times, continuously executing the spraying and the preheating.

19. The cold starting method of claim 12, wherein:
the fuel is the bioethanol fuel.
